(19) United States
(12) Patent Application Publication
(10) Pub. No.: US 2019/0298043 A1
(43) Pub. Date: Oct. 3, 2019

(54) INSTRUMENT CASE FOR USE BY OPERATOR SUSPENDED FROM HARNESS

(71) Applicants: Matthew RODGERS, Marlborough, MA (US); Coleman FLANAGAN, Marlborough, MA (US)

(72) Inventors: Matthew RODGERS, Marlborough, MA (US); Coleman FLANAGAN, Marlborough, MA (US)

(73) Assignee: Olympus Scientific Solutions Americas Inc., Waltham, MA (US)

(21) Appl. No.: 15/941,933

(22) Filed: Mar. 30, 2018

(51) Int. Cl. A45F 5/00; G01D 11/30; G01D 11/24

(52) U.S. Cl. CPC A45F 5/00; A45F 2005/008; G01D 11/245; G01D 11/30

(57) ABSTRACT

Disclosed is an instrument case for use by an operator suspended from a harness. The instrument case is preferably attached to the operator's thigh by means of a thigh strap which is rotatably attached to the instrument case. Pull straps are attached to the instrument case at one end and to the operator's harness or belt at the other end. By adjusting the tension in the pull straps, the operator may adjust the orientation of the instrument touch screen to optimize its visibility and accessibility.

### FIELD OF THE INVENTION

The invention relates to a case for an instrument used for non-destructive test and inspection (NDT/NDI), and in particular to a case which is pivotably attached to the operator's thigh while the operator may be suspended from a harness.

### BACKGROUND OF THE INVENTION

NDT/NDI instruments, such as ultrasound or eddy current instruments, are often used for routine inspection to identify flaws and verify the integrity and of pipes, tubes, metallic joints and the like. Often access to the parts to be inspected is difficult, and in some cases, such as inspection of offshore oil platform supports and in-service inspection of wind turbine towers and blades, it is necessary for the operator to be suspended from a harness in order to perform the inspection.

In general, NDT/NDI inspection is performed by means of a handheld probe attached with a cable to the instrument. The instrument has a display screen, often a touch-sensitive screen, which must be visible and accessible to the operator while performing the inspection. In normal operation, the operator manipulates the probe on the surface to be inspected using one hand, while the instrument may be held in the other hand or placed on a convenient nearby surface. However, there is unlikely to be a convenient nearby surface for an operator suspended from a harness, and the operator will usually prefer to use one hand to hold on to a structure or harness for balance and safety. The other hand must be used to manipulate the probe, while the instrument must be securely attached in such a way that the operator can easily see and touch the screen. To enhance visibility and convenience, the operator should be able adjust the orientation of the screen depending on the position of his body in the harness.

Use of existing NDT/NDI instruments by an operator in a harness is awkward because there is no convenient way for the operator to securely and conveniently attach the instrument. There therefore exists a need for an attachment method which is secure and allows convenient and adjustable visibility of the instrument screen, without interfering with other safety harness ropes and connections

### SUMMARY OF THE INVENTION

Accordingly, it is a general objective of the present disclosure to have a case for an NDT instrument which is securely and conveniently attached to the operator.

It is further an objective of the present disclosure to attach the instrument case to the operator in such a way that the operator may vary the orientation of the instrument to enhance the visibility and accessibility of the instrument touch screen.

These objectives and others are achieved by enclosing the instrument in a case to which is attached at least one thigh strap and at least one pull strap. The thigh strap is configured to attach securely to the operator's body, preferably to the operator's thigh. The attachment of the thigh strap to the case allows rotation of the case relative to the thigh strap. The pull strap is configured to attach to the operator's belt or to the safety harness. By adjusting the tension in the pull strap, the operator may adjust the orientation of the case, thereby adjusting the viewing angle of the instrument screen.

### BRIEF DESCRIPTION OF THE DRAWINGS

FIG. 1 is a photograph of an operator suspended from a harness with attachment of an instrument case according to the present disclosure.

FIG. 2 is an isometric view of an embodiment of an instrument case assembly according to the present disclosure.

FIG. 3A a side view of an instrument case in a first orientation according to the present disclosure.

FIG. 3B a side view of an instrument case in a second orientation according to the present disclosure.

### DETAILED DESCRIPTION OF PREFERRED EMBODIMENT

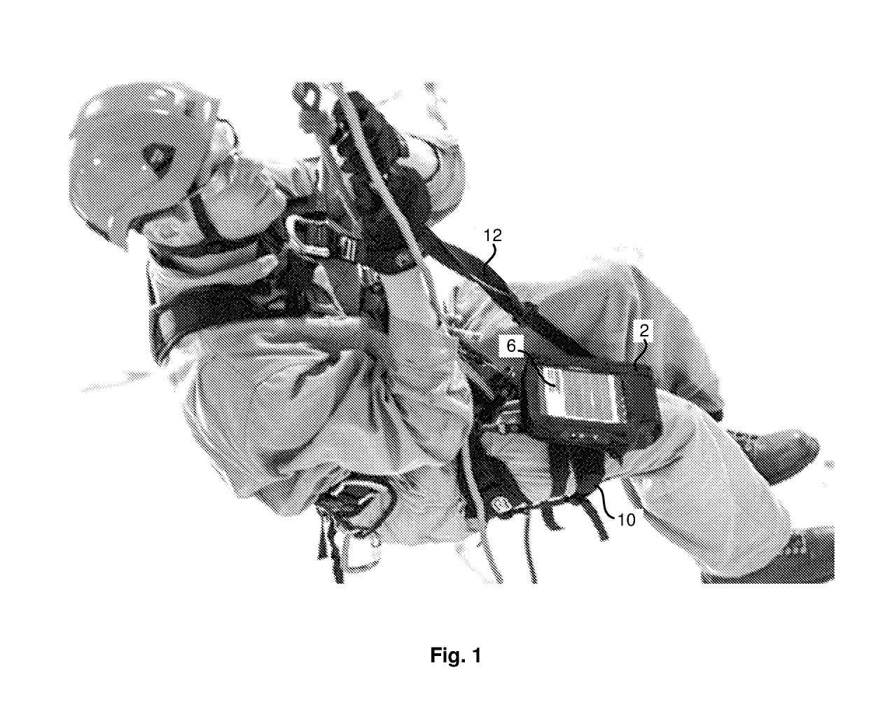

FIG. 1 is a photograph of an operator suspended from a harness with an instrument case 2 attached to his thigh by means of a thigh strap 10. Instrument case 2 encloses an instrument 4 having a touch screen 6 within easy view of the operator. A pull strap 12 is attached to instrument case 2 at one end and at the other end to a clip on the harness (not shown).

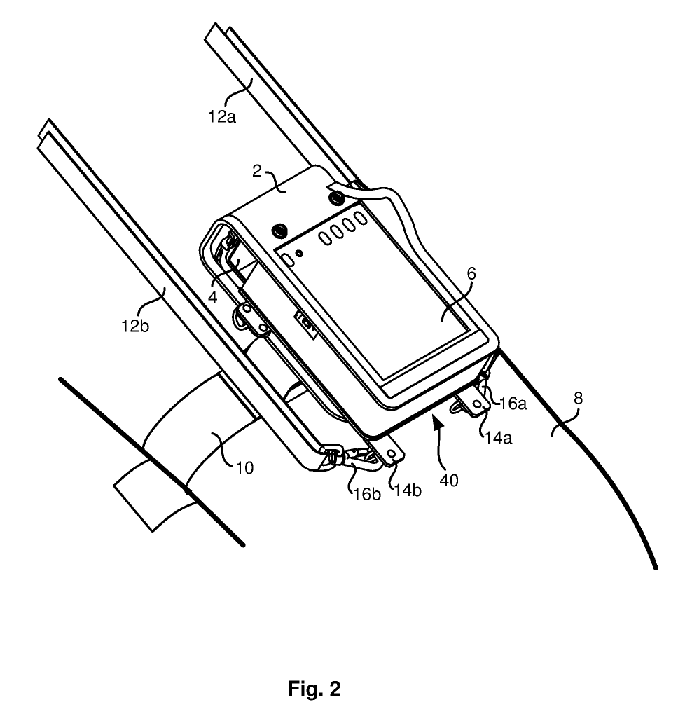

FIG. 2 is an isometric diagram of an instrument case assembly 1, comprising instrument case 2 attached by means of thigh strap 10 to a thigh 8 of the operator. Note that thigh strap 10 may be used to attach instrument case 2 to any other part of the operator's body, such as an arm, and all such attachments are within the scope of the present disclosure. The attachment of thigh strap 10 to instrument case 2 is configured to allow rotation of instrument case 2 relative to thigh strap 10.

In an embodiment, attachment of thigh strap 10 to instrument case 2 may be achieved by means of a thigh strap attachment loop (not shown) attached to the rear side of instrument case 2. Thigh strap 10 may have an open configuration and a closed configuration, wherein in the open configuration thigh strap 10 is passed through the thigh strap attachment loop. Thigh strap 10 in the open configuration is then wrapped around thigh 8 and attachment of the thigh strap ends forms the closed configuration. Attachment of the ends of thigh strap 10 may be by means of snap fasteners, velcro fasteners or any other attachment means.

Note that other forms of attachment of thigh strap 10 to instrument case 2, such as snap fasteners or velcro fasteners, are possible and within the scope of the present disclosure.

In the embodiment illustrated in FIG. 2, instrument case assembly 1 further comprises two pull straps 12a and 12b which are attached to instrument case 2 at attachment points 14a and 14b by means of attachment devices 16a and 16b respectively. The specific forms of attachment points 14a and 14b and attachment devices 16a and 16b are shown in FIG. 2 for illustrative purposes only. Any form of attachment known in the art may be used and all such attachments are within the scope of the present disclosure. Instrument case 2 may optionally comprise alternative attachment points 15a (not shown) and 15b.

Note that pull straps 12a and 12b serve dual functions, namely (a) securing instrument case 2 in the event of any failure of thigh strap 10, and (b) adjusting the orientation of instrument case 2 in order to enhance the visibility and accessibility of touch screen 6.

The ends of pull straps 12a and 12b remote from attachment points 14a and 14b are not shown in FIG. 2. These ends may be equipped with attachment devices configured to attach to clips, belts, loops and the like. For example, pull straps 12a and 12b may be attached to the operator's harness or to the operator's belt. Pull straps 12a and 12b may be configured so that their lengths may be easily adjusted by the operator, the length adjustment being implemented by length adjustment means such as loops and buckles which are well known in the art. The attachments and configurations of pull straps 12a and 12b are preferably arranged so that the operator can vary the length and/or the tension in the straps.

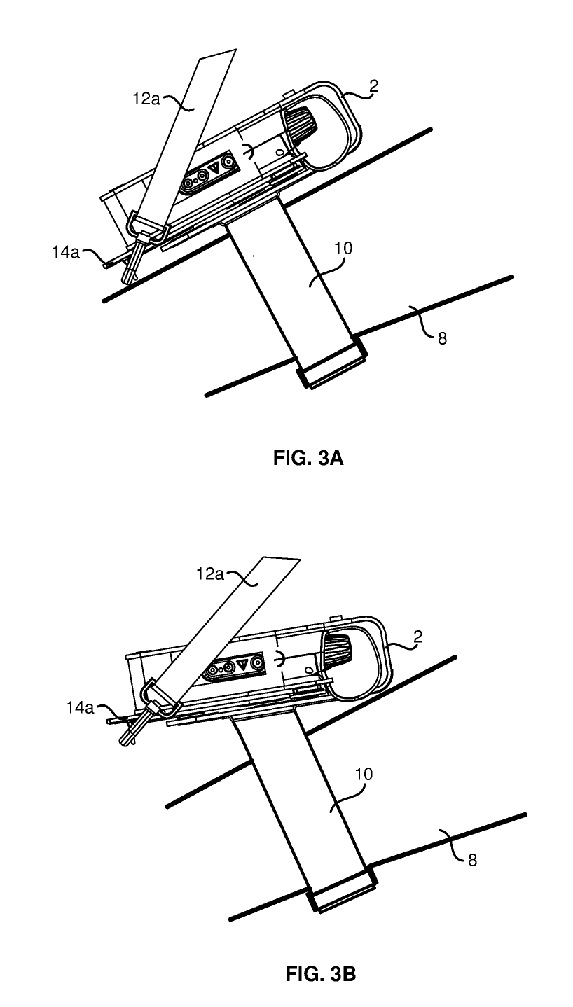

FIGS. 3A and 3B show side views of instrument case 2 attached to thigh 8 of the operator. In FIG. 3A the tension in pull straps 12a and 12b is relaxed and attachment points 14a and 14b are substantially resting on thigh 8. In FIG. 3B the tension in pull straps 12a and 12b is increased so that attachment points 14a and 14b are lifted up from thigh 8, thereby rotating instrument case 2. Thus, by increasing the tension in pull straps 12a and 12b, the operator may obtain a better view of and easier access to touch screen 6, without needing to move thigh 8 to a different position.

Note that as shown in FIGS. 3A and 3B, rotation of instrument case 2 is about an axis substantially parallel to the plane of touch screen 6 and substantially perpendicular to the orientation of pull straps 12a and 12b. However, by applying unequal tension to pull straps 12a and 12b, the operator may also effect rotation of instrument case 2 about an axis substantially perpendicular to the plane of touch screen 6, and such rotation is within the scope of the present disclosure.

Note that instrument case 2 may optionally be equipped with a removable or foldable cover (not shown) for protection of touch screen 6 when instrument 4 is not in use. The cover may be attached to instrument case 2 by means of snap fasteners, velcro fasteners or any other type of fastener. In order to use instrument 4, the operator undoes the fastener and removes or folds back the cover.

Instrument case 2 may optionally comprise apertures in the rear or sides for access to connections and controls of instrument 4.

Instrument case 2 is preferably constructed of woven fabric or mesh fabric material, but may be constructed of metal, plastic or any other suitable material.

Instrument case 2 optionally comprises alternative attachment points 15a and 15b. In an embodiment, alternative attachment points 15a and 15b may be located on the opposite side of instrument case 2 from attachment points 14a and 14b, so that the operator may choose to use instrument case 2 in a configuration reversed from that shown in FIG. 2. In this case, the display software of touch screen 6 should be configured to correct the orientation of the displayed image.

Although the present invention has been described in relation to particular embodiments thereof, it can be appreciated that various designs can be conceived based on the teachings of the present disclosure, and all are within the scope of the present disclosure.

What is claimed is:

1. An industrial testing/measuring instrument assembly comprising:
an industrial testing/measuring instrument; and,
an instrument case assembly for use by an operator who can wear a harness, the instrument case assembly further comprising:
an instrument case configured for enclosing an instrument, the instrument case having a periphery, the instrument having a display screen;
at least one body strap configured to be attached to the instrument case and the operator; and
at least one pull strap having a first end configured to be attached to the instrument case at an attachment point substantially at the periphery of the instrument case and a second end configured to be attached to the operator or the harness,
the at least one pull strap is configured to be adjusted in length by the operator to cause a tilt of the instrument case and to hold the instrument at an angle to enhance visibility of the display screen to the operator.

2. The instrument assembly of claim 1 wherein the at least one body strap is a thigh strap, and the thigh strap is configured to be attached to a thigh of the operator.

3. The instrument assembly of claim 1 wherein the display screen is a touch screen and the tilt of the instrument case enhances accessibility of the operator to the touch screen.

4. The instrument assembly of claim 2 wherein the instrument case has a display screen side and a rear side, wherein the rear side is opposite the display screen side, and wherein a thigh strap attachment loop is attached to the rear side.

5. The instrument assembly of claim 4 wherein the thigh strap has an open configuration and a closed configuration, wherein the thigh strap in the open configuration is passed through the thigh strap attachment loop.

6. The instrument assembly of claim 5 wherein the thigh strap in the open configuration is configured to be wrapped around the thigh and an attachment of thigh strap ends forms the closed configuration.

7. The instrument assembly of claim 6 wherein the attachment of the thigh strap ends is by means of hook-and-loop fasteners.

8. The instrument assembly of claim 6 wherein the attachment of the thigh strap ends is by means of snap fasteners.

9. The instrument assembly of claim 1 wherein the at least one pull strap is configured with an adjustable length.

10. The instrument assembly of claim 1 wherein the attachment point is at a furthest periphery of the instrument case relative to the operator and the tilt of the instrument case is about an axis substantially parallel to a plane of the display screen.

11. The instrument assembly of claim 1 wherein the tilt of the instrument case is about an axis substantially perpendicular to the plane of the display screen.

12. The instrument assembly of claim 1 wherein the instrument case further comprises a display screen cover configured to cover the display screen when the instrument is not in use.

13. The instrument assembly of claim 12 wherein the display screen cover is attached to the instrument case by means of hook-and-loop fasteners.

14. The instrument assembly of claim 1 wherein the instrument case further comprises apertures for access to instrument controls and instrument connectors.

15. The instrument assembly of claim 1 wherein the instrument case is made of webbing material.

16. The instrument assembly of claim 1 wherein the instrument case is made of plastic material.

17. The instrument assembly of claim 1 wherein the instrument case is made of metal material.

18. The instrument assembly of claim 1 wherein the at least one body strap is made of webbing material.

19. The instrument assembly of claim 1 wherein the at least one pull strap is made of webbing material.

20. An instrument case assembly for use by an operator who can wear a harness, the instrument case assembly comprising:
an instrument case configured for enclosing an instrument, the instrument case having a periphery, the instrument having a display screen;
at least one body strap configured to be attached to the instrument case and the operator; and
at least one pull strap having a first end configured to be attached to the instrument case at an attachment point substantially at the periphery of the instrument case and a second end configured to be attached to the operator or the harness and
the at least one pull strap is configured to be adjusted in length by the operator to cause a tilt of the instrument case and to hold the instrument at an angle to enhance visibility of the display screen to the operator.
